(19) United States
(12) Patent Application Publication
(10) Pub. No.: US 2017/0024533 A1
(43) Pub. Date: Jan. 26, 2017

(54) SYSTEM AND METHOD FOR NOTIFYING USER OF CURRENT EXERCISE STATE IN REAL TIME

(71) Applicant: FIT.LIFE INC., Gyeonggi-do (KR)

(72) Inventors: Yoo Suk JUNG, Gyeonggi-do (KR); Soon Dong KIM, Gyeonggi-do (KR)

(73) Assignee: Fit.Life Inc., Gyeonggi-do (KR)

(21) Appl. No.: 15/302,465

(22) PCT Filed: Apr. 6, 2015
(86) PCT No.: PCT/KR2015/003403

§ 371 Date: Oct. 6, 2016

(30) Foreign Application Priority Data
Apr. 18, 2014 (KR) 10-2014-0046658

(51) Int. Cl. G06F 19/00

(52) U.S. Cl. CPC G06F 19/3406; G06F 19/3481

(57) ABSTRACT

A system and a method for notifying a user of a current exercise state in real time are disclosed. The system for notifying a user of a current exercise state in real time, according to an embodiment of the present invention, comprises: an exercise program module for generating an exercise program suitable for the user by using information on the user's physical fitness and diseases; an exercise amount measurement module for measuring exercise intensity and exercise time according to the user's exercise; and a feedback module determining whether the user's exercise has satisfied the requirements of the generated exercise program by using the measured exercise intensity and exercise time so as to provide the results to the user as feedback in real time.

### FIELD

The present invention relates to a system and a method for notifying a current state of exercise in real time, and in more detail, relates to a technology for checking and real-time notifying of whether intensity and time of exercise currently performed by a user carry through an exercise program including intensity and time of exercise given according to physical strength and condition of the user and intensity and time of next exercise depending on whether the exercise program is carried through.

### BACKGROUND

Since obese or overweight people gradually increase due to hypernutrition and insufficient exercise, the necessity of health care of modern people gradually increases. Additionally, recently, ordinary healthy people are more interested in their health and such interest has been embodied by development of technology and social needs with a realizable possibility of ubiquitous health care.

Products which reflect the interest of modern people in health have been introduced. Technologies applied to products described above may be largely classified into a real-time feedback technology of notifying a current state of exercise of a user to the user in real time and a non-real time feedback technology of notifying a result after exercise of the user is completed.

The real-time feedback technology is a technology of measuring exercise intensity of the user by measuring a heat rate of the user using a cardiograph and notifying next exercise intensity of the user in real time based on the measured exercise intensity.

However, in the real-time feedback technology, since there is no consideration on appropriate exercise time and whether exercise continues, it is impossible to check how much time the user has to do exercise and how many times the user repeat the exercise. Also, since the real-time feedback technology merely notifies next exercise intensity without considering a present condition of physical strength or a medical condition of the user, exercise intensity inappropriate for the user may be recommended.

Meanwhile, the non-real time technology is a technology of determining whether calorie consumption or movement distance of the user calculated based on values sensed using an impact sensor, etc. carries through a target value of calorie consumption or movement distance and notifying a result thereof.

However, the non-real time feedback technology is a method of notifying whether a target value of calorie consumption or a movement distance after the exercise of the user is completed. Due to this, users who do exercise using products to which the non-real time feedback technology is applied may have difficulty in being motivated to do exercise currently performed. Also, since the non-real time feedback technology is a method without considering exercise intensity, exercise time, etc. of users, it is impossible for users to recognize how long exercise should be continued by users.

Meanwhile, as a prior document of the related art, there is present Korean Patent Publication No. 10-2012-0098854 (Sep. 5, 2012).

### DISCLOSURE OF INVENTION

### Technical Problem

The present invention provides a system and a method for notifying a current state of exercise in real time by checking whether exercise intensity and time currently performed by a user carry through an exercise program including intensity and time of exercise given according to physical strength and condition of the user and whether intensity and time of next exercise according to the carrying of the exercise program and notifying them in real time.

Additional aspects of the present disclosure will be set forth in part in the description which follows and, in part, will be obvious from the description, or may be learned by practice of the present disclosure.

### Technical Solution

According to an aspect of the present invention, a system for notifying a current state of exercise in real time includes an exercise program module which generates an exercise program appropriate for a user using physical strength and condition information of the user, an exercise amount measuring module which measures exercise intensity and exercise time according to exercise of the user, and a feedback module which checks whether the exercise of the user satisfies the generated exercise program using the measured exercise intensity and exercise time and provides the user with a checking result as a feedback in real time.

The exercise program module may store exercise programs according to physical strength for each condition and may check an exercise program corresponding to the physical strength and condition information of the user among the exercise programs according to the physical strength for each condition and may determine the exercise program as the generated exercise program.

The generated exercise program may include exercise intensity, exercise time, and exercise times appropriate for the user and whether to continue exercise.

The system may further include a physical strength measuring apparatus which measures physical strength of the user.

The system may further include a physical strength estimating module which estimates physical strength of the user using age, gender, and a relative physical strength level of the user.

According to an aspect of the present invention, a method for notifying a current state of exercise in real time includes generating an exercise program appropriate for a user using physical strength and condition information of the user, measuring exercise intensity and exercise time according to exercise of the user, and checking whether the exercise of the user satisfies the generated exercise program using the measured exercise intensity and exercise time and providing the user with a checking result as a feedback in real time.

The generating of the exercise program may include checking an exercise program corresponding to the physical strength and condition information of the user among preset exercise programs according to physical strength for each medical condition and determining the exercise program as the generated exercise program.

### Advantageous Effects

According to embodiments of the present invention, there are provided a system and a method for notifying a current state of exercise in real time in which whether intensity and time of exercise currently performed by a user carry through an exercise program including intensity and time of exercise given according to physical strength and condition of the user and intensity and time of next exercise depending on whether the exercise program is carried through may be checked and notified to the user in real time.

### BRIEF DESCRIPTION OF DRAWINGS

FIG. 1 is a configuration diagram of a system for notifying a current state of exercise in real time according to an embodiment of the present invention.

FIG. 2 is a flowchart illustrating a method of notifying a current state of exercise in real time according to an embodiment of the present invention.

### BEST MODE

Hereinafter, exemplary embodiments of the present invention will be described in detail with reference to the attached drawings.

The embodiments of the present invention are provided to more completely explain the present invention to one of ordinary skill in the art. The following embodiments may be modified into various other forms, and the scope of the present invention is not limited thereto. The embodiments are provided to make the disclosure more substantial and complete and to completely convey the concept to those skilled in the art.

The terms used herein are to explain particular embodiments but do not limit the present invention. As used herein, singular expressions, unless contextually defined otherwise, may include plural expressions. Also, the terms “comprise” and/or “comprising” are used herein to specify the present of stated shapes, numbers, steps, operations, members, elements, and/or groups thereof but don not preclude the presence or addition of one or more other shapes, numbers, operations, members, elements and/or groups thereof. As used herein, the term “and/or” includes any and all combinations or one of a plurality of associated listed items.

It should be understood that although the terms “first”, “second”, etc. are used herein to describe various members, areas, layers, and/or portions, these members, areas, layers and/or portions are not limited by these terms. These terms do not mean particular order, top and bottom, or ratings but are used only to distinguish one member, area, or portion from another member, area, or portion. Accordingly, a first member, area, or portion which will be described below may be referred to as a second member, area, or portion without departing from the scope of the present invention.

Hereinafter, the embodiments of the present invention will be described with reference to the drawings which schematically illustrate the embodiments. In the drawings, for example, depending on a manufacturing technology and/or tolerance, modifications of illustrated shapes may be expected. Accordingly, it should be understood that the embodiments of the present invention are not limited to particular shapes in areas shown in the specification and may include, for example, changes in shape caused during a manufacturing process.

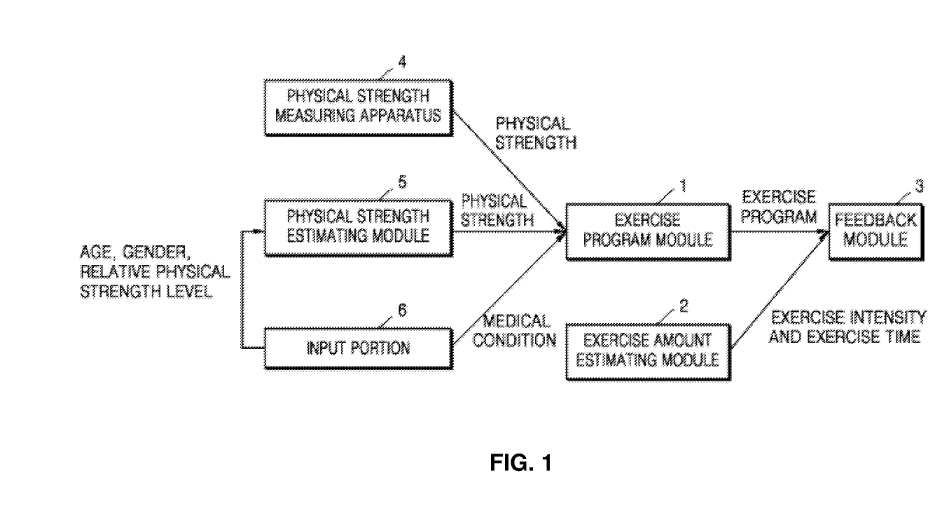

FIG. 1 is a configuration diagram of a system for notifying a current state of exercise in real time according to an embodiment of the present invention.

Referring to FIG. 1, a system for notifying a current state of exercise in real time according to the embodiment of the present invention includes an exercise program module 1, an exercise amount measuring module 2, and a feedback module 3.

The exercise program module 1 generates an exercise program appropriate for a user using physical strength and condition information of the user. For this, the exercise program module 1 stores exercise programs according to physical strength for each condition and may check an exercise program corresponding to the physical strength and condition information of the user among the exercise programs according to the physical strength for each condition and may determine it as the generated exercise program. Here, for example, when the user has diabetes, the exercise program module 1 may store an exercise program according to diabetic physical strength. However, not limited thereto, it should be known that exercise programs appropriate for physical strength for each of other diseases in addition to diabetes are also stored.

Here, the physical strength may be directly measured through a physical strength measuring apparatus 4 or may be estimated through a physical strength estimating module 5. That is, the system for notifying the current state of exercise in real time according to the embodiment of the present invention may include at least one of the physical strength measuring apparatus 4 and the physical strength estimating module 5. The physical strength measuring apparatus 4 may be a breathing gas analyzer but is not limited thereto. A reason that the system for notifying the current state of exercise in real time according to the embodiment of the present invention includes the physical strength estimating module 5 is to solve a problem that the system for notifying the current state of exercise in real time according to the embodiment of the present invention costs high because the physical strength measuring apparatus 4 is generally expensive. Meanwhile, the physical strength estimating module 5 may receive age, gender, and relative physical strength level of the user and may estimate physical strength of the user. Here, the age, gender, and relative physical strength level of the user may be input through an input portion 6. Similarly, medical condition information input to the exercise program module 1 may also input through the input portion 6.

The exercise program generated at the exercise program module 1 may include exercise intensity, exercise time, times of doing exercise and whether exercise continues appropriate for the user. The information included in the exercise program generated as described above may be output through a screen of a terminal provided in the system for notifying the current state of exercise in real time or a screen of a terminal connected to the exercise program module 1 through a network. As an embodiment, the exercise program output on the screen of the terminal provided in the system for notifying the current state of exercise in real time or the screen of the terminal connected to the exercise program module 1 through the network may be expressed in the forms such as how many days in a week, how many times in a day, how many minutes in one time, exercise intensity, whether it is necessary to continuously exercise, etc. Whether it is necessary to continuously exercise indicates whether to continuously or discontinuously do exercise at the exercise intensity.

The exercise amount measuring module 2 measures exercise intensity and exercise time according to exercise of the user. The exercise amount measuring module 2 may be included in the system for notifying the current state of exercise in real time or may be provided as a separate apparatus outside the system for notifying the current state of exercise in real time. Here, the type of the exercise intensity measured by the exercise amount measuring module 2 includes at least one of an exercise amount of the user, an exercise calorie consumption amount of the user, an exercise oxygen amount of the user, and exercise heart rate of the user, etc. Accordingly, the exercise amount measuring module 2 may be one of a pedometer, a cardiograph, an aeroplethysmograph, etc. The calorie consumption amount of the user may be shown by a unit of Kcal or a metabolic equivalent (MET). The exercise oxygen amount of the user may be shown as a symbol of VO₂R and indicates an oxygen amount obtained by deducting an oxygen amount necessary for basal metabolism from a maximal oxygen amount VO_{2Max} that the user can maximally breathe. That is, the exercise calorie consumption amount of the user indicates an oxygen amount available while the user does exercise.

The feedback module 3 checks whether the exercise of the user satisfies the generated exercise program using the measured exercise intensity and exercise time and provides a feedback to the user in real time. The feedback may include a compensation method for compensating user's defect. As an embodiment for this, when the exercise intensity is short compared with a reference, the feedback module 3 may provide the user with a feedback as a message in which the exercise intensity is short and it is necessary to increase the exercise intensity at certain time intervals until the exercise intensity becomes appropriate for the reference. Also, when the exercise intensity is too high compared with the reference, a message in which the exercise intensity is excessive and it is necessary to decrease the intensity at certain time intervals until the exercise intensity becomes appropriate for the reference.

Checking whether the exercise of the user satisfies the generated exercise program using the measured exercise intensity and exercise time may sequentially include determining whether the measured exercise intensity and exercise time satisfy exercise intensity and exercise time in the generated exercise program and after that determining whether exercise times and continuity of exercise in the generated exercise program are satisfied using the measured exercise intensity and exercise time. However, it is not limited thereto. Particularly, a process of determining whether the exercise times and the continuity of exercise in the generated exercise program are satisfied will be described as an example. For example, when the number of the exercise times in the generated exercise program in which exercise at a certain level of intensity continues for 10 minutes or more is 5 while the number of exercise times in which the measured exercise intensity at a certain level or higher continues 10 minutes or more is 4, the feedback module 3 may determine that the exercise of the user does not satisfy the generated exercise program.

The configuration of the system for notifying the current state of exercise in real time according to the embodiment of the present invention shown in FIG. 1 is merely classified in a functional point of view and does not mean an actual implementing method or hardware method. At least one module shown in FIG. 1 may be integrated as or subdivided into one or more modules, and it will be obvious to one of ordinary skill in the art.

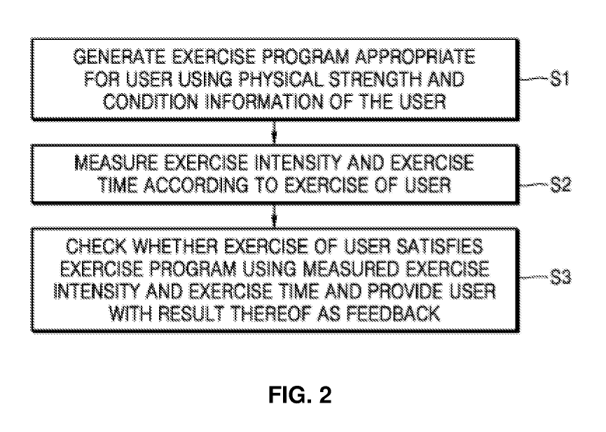

FIG. 2 is a flowchart illustrating a method of notifying a current state of exercise in real time according to an embodiment of the present invention.

The method of notifying the current state of exercise in real time according to the embodiment of the present invention shown in FIG. 2 may be executed by the system for notifying the current state of exercise in real time according to the embodiment of the present invention.

The system for notifying the current state of exercise in real time generates an exercise program appropriate for a user using physical strength and condition information of the user (S1). Here, the physical strength of the user may be measured through the physical strength measuring apparatus 4 shown in FIG. 1 or may be estimated through the physical strength estimating module 5 shown in FIG. 1. The physical strength estimating module 5 may estimate the physical strength of the user using age, gender, and a relative physical strength level of the user input through the input portion 6. The condition information may be input through the input portion 6 shown in FIG. 1.

The system for notifying the current state of exercise in real time using the input information described above may check an exercise program corresponding to the physical strength and condition information of the user among preset exercise programs according to physical strength for each medical condition and may determine the exercise program as the generated exercise program. The generated exercise program may include exercise intensity, exercise time, and exercise times appropriate for the user and whether to continue exercise.

The system for notifying the current state of exercise in real time measures exercise intensity and exercise time according to exercise of the user (S2). Here, the exercise intensity and exercise time according to exercise of the user may be measured by the exercise amount measuring module 2 shown in FIG. 1 and the type of the measured exercise intensity may include at least one of an exercise amount of the user, an exercise calorie consumption amount of the user, an exercise oxygen amount of the user, and an exercise heat rate of the user.

The generating of the exercise program in the operation S1 and the measuring of the exercise intensity and exercise time in the operation S2 may be performed at the same time. Otherwise, the generating of the exercise program may be performed and then the measuring of the exercise intensity and exercise time may be performed. Otherwise, the measuring of the exercise intensity and exercise time may be performed and then the generating of the exercise program may be performed. However, most preferably, the generating of the exercise program may be performed and then the measuring of the exercise intensity and exercise time may be performed sequentially.

The system for notifying the current state of exercise in real time checks whether the exercise of the user satisfies the generated exercise program using the measured exercise intensity and exercise time and provides a feedback to the user in real time (S3).

While the embodiments of the present invention have been described, it would be appreciated by one of ordinary skill in the art that changes may be made in these embodiments without departing from the essential features of the present invention. Therefore, the disclosed embodiments should be considered not in a limitative point of view but in a descriptive point of view. Accordingly, it should be understood that the scope of the present invention is not limited to the embodiments described above and includes various modifications within the range of the content defined in the claims and equivalents thereof.

### INDUSTRIAL APPLICABILITY

The present invention may be applicable to the field of a ubiquitous health care technology.

1. A system for notifying a current state of exercise in real time, comprising:
an exercise program module which generates an exercise program appropriate for a user using physical strength and condition information of the user;
an exercise amount measuring module which measures exercise intensity and exercise time according to exercise of the user; and
a feedback module which checks whether the exercise of the user satisfies the generated exercise program using the measured exercise intensity and exercise time and provides the user with a checking result as a feedback in real time.

2. The system of claim 1, wherein the exercise program module stores exercise programs according to physical strength for each medical condition, checks an exercise program corresponding to the physical strength and condition information of the user among the exercise programs according to the physical strength for each medical condition, and determines the exercise program as the generated exercise program.

3. The system according to claim 1, wherein the generated exercise program comprises exercise intensity, exercise time, and exercise times appropriate for the user and whether to continue exercise.

4. The system of claim 1, further comprising a physical strength measuring apparatus which measures physical strength of the user.

5. The system of claim 1, further comprising a physical strength estimating module which estimates physical strength of the user using age, gender, and a relative physical strength level of the user.

6. A method of notifying a current state of exercise in real time, comprising:
generating an exercise program appropriate for a user using physical strength and condition information of the user;
measuring exercise intensity and exercise time according to exercise of the user; and
checking whether the exercise of the user satisfies the generated exercise program using the measured exercise intensity and exercise time and providing the user with a checking result as a feedback in real time.

7. The method of claim 6, wherein the generating of the exercise program comprises checking an exercise program corresponding to the physical strength and condition information of the user among preset exercise programs according to physical strength for each medical condition and determining the exercise program as the generated exercise program.

8. The method according to claim 6, wherein the generated exercise program comprises exercise intensity, exercise time, and exercise times appropriate for the user and whether to continue exercise.

9. The method of claim 6, further comprising measuring physical strength of the user using a physical strength measuring apparatus.

10. The method of claim 6, further comprising estimating physical strength of the user using age, gender, and a relative physical strength level of the user using a physical strength estimating module.

11. The system according to claim 2, wherein the generated exercise program comprises exercise intensity, exercise time, and exercise times appropriate for the user and whether to continue exercise.

12. The method according to claim 7, wherein the generated exercise program comprises exercise intensity, exercise time, and exercise times appropriate for the user and whether to continue exercise.
